(19) United States
(12) Patent Application Publication
(10) Pub. No.: US 2017/0118571 A1
(43) Pub. Date: Apr. 27, 2017

(54) ELECTRONIC APPARATUS AND SOUND SIGNAL ADJUSTMENT METHOD THEREOF

(71) Applicant: AVerMedia Technologies, Inc., New Taipei City (TW)

(72) Inventors: Chun-Hao Peng, New Taipei City (TW); Yan-Min Kuo, New Taipei City (TW); Tien-Li Kuo, New Taipei City (TW); Li-Yen Lin, New Taipei City (TW); Kuo-Lien Ma, New Taipei City (TW); Hsi-Pang Wang, New Taipei City (TW); Yung-Ching Chu, New Taipei City (TW); Che-Yung Huang, New Taipei City (TW)

(21) Appl. No.: 15/297,205

(22) Filed: Oct. 19, 2016

(30) Foreign Application Priority Data
Oct. 23, 2015 (TW) 104134794

(51) Int. Cl. H04S 7/00; H04S 1/00

(52) U.S. Cl. CPC H04S 7/301; H04S 1/007

(57) ABSTRACT

An electronic apparatus includes a sound-receiving module and a processor. The electronic apparatus is electronically connected to a first sound device and a second sound device. The first sound device receives a first sound signal having a first channel audio from the electronic apparatus and plays the first channel audio. The second sound device receives a second sound signal having a second channel audio from the electronic apparatus and plays the second channel audio. The sound-receiving module receives an audio to generate an input signal. The processor electrically connected to the sound-receiving module compares the input signal and a predetermined value. When the input signal is less than the predetermined value, the processor adjusts the first and second sound signals for the first sound device receiving the second sound signal and for the second sound device receiving the first sound signal.

### CROSS REFERENCE TO RELATED APPLICATIONS

This Non-provisional application claims priority under 35 U.S.C. §119(a) on Patent Application No. 104134794 filed in Taiwan, Republic of China on Oct. 23, 2015, the entire contents of which are hereby incorporated by reference.

### BACKGROUND

1. Technical Field

The disclosure relates to an electronic apparatus and a sound signal adjustment method, in particularly, to an electronic apparatus and a sound signal adjustment method that can convert the audio channel easily.

2. Description of Related Art

Stereophonic sound or, more commonly, stereo, is a method of sound reproduction that creates an illusion of multi-directional audible perspective. This is usually achieved by using two or more independent audio channels through a configuration of two or more loudspeakers (or stereo headphones) in such a way as to create the impression of sound heard from various directions, as in natural hearing.

Normally, a sound system includes a right channel speaker, a left channel speaker and an electronic apparatus (host). The sound system is set up by the user, in other words, the right channel speaker may be electrically connected to a left channel terminal of the electronic apparatus and the left channel speaker may be electrically connected to a right channel terminal of the electronic apparatus so as to reduce the sound quality of the sound system.

It is therefore an important subject of the invention to provide an electronic apparatus and a sound signal adjustment method to ensure the audio is delivered from the correct speaker without to reinstall if the speakers are located at wrong position.

### SUMMARY OF THE INVENTION

In view of the foregoing, the invention is to provide an electronic apparatus and a sound signal adjustment method to broadcast the audio from the correct channel.

To achieve the above, an electronic apparatus is provided that is electrically connected to a first sound device and a second sound device. The first sound device receives a sound signal of a first channel and plays an audio of the first channel according to the sound signal of the first channel. The second sound device receives a sound signal of a second channel and plays an audio of the second channel according to the sound signal of the second channel. The electronic apparatus includes an output module, a processor, a first sound-receiving module and a second sound-receiving module. The output module is electrically connected to the first sound device and the second sound device. The sound signal of the first channel and the sound signal of the second channel are transmitted to the first sound device and the second sound through the output module. The processor, which is electrically connected to the output module, outputs a reference signal of the first channel to the first sound device through the output module. The first sound device plays a reference audio of the first channel according to the reference signal of the first channel, which is received from the output module. The first sound-receiving module is electrically connected to the processor for receiving the reference audio of the first channel so as to generate a first input signal. The second sound-receiving module is electrically connected to the processor for receiving the reference audio of the first channel so as to generate a second input signal. The processor receives the first input signal and the second input signal for calculating a receiving time span between the first input signal and the second input signal. When the receiving time of the first input signal is late than the receiving time of the second input signal, the processor controls the first sound device to receive the sound signal of the second channel and controls the second sound device to receive the sound signal of the first channel.

To achieve the above, a sound signal adjustment method cooperating with an electronic apparatus is provided. The electronic apparatus is electrically connected to a first sound device and a second sound device. The first sound device receives a sound signal of a first channel and plays an audio of the first channel according to the sound signal of the first channel. The second sound device receives a sound signal of a second channel and plays an audio of the second channel according to the sound signal of the second channel. The sound signal adjustment method includes the following steps. Generating a reference signal of the first channel; transmitting the reference signal of the first channel to the first sound device so as to play a reference audio of the first channel according to the reference signal of the first channel; receiving the reference audio of the first channel by the first sound-receiving module so as to generate a first input signal; receiving the reference audio of the first channel by the second sound-receiving module so as to generate a second input signal; receiving the first input signal and the second input signal; calculating a receiving time span between the first input signal and the second input signal; and controlling the first sound device to receive the sound signal of the second channel and controlling the second sound device to receive the sound signal of the first channel when the receiving time of the first input signal late than the receiving time of the second input signal.

In addition, to achieve the above, an electronic apparatus is provided, which includes an output module, a sound-receiving module and a processor. The output module is electrically connected to the first sound device and a second sound device. The first sound device receives a sound signal of a first channel and plays an audio of the first channel according to the sound signal of the first channel. The second sound device receives a sound signal of a second channel and plays an audio of the second channel according to the sound signal of the second channel. The output module is electrically connected to the first sound device and the second sound device to transmit the sound signal of the first channel and the sound signal of the second channel. The sound-receiving module is located between the first sound device and the second sound device for receiving an audio so as to generate an input signal. The processor is electrically connected to the output module and the sound-receiving module for receiving the input signal and comparing the input signal with a predetermined signal. When the input signal is less than the predetermined signal, the first sound device is controlled by the processor to receive the sound signal of the second channel and the second sound device is controlled by the processor to receive the sound signal of the first channel.

To achieve the above, a sound signal adjustment method cooperating with an electronic apparatus is provided. The electronic apparatus is electrically connected to a first sound device and a second sound device. The first sound device receives a sound signal of a first channel and plays an audio of the first channel according to the sound signal of the first channel. The second sound device receives a sound signal of a second channel and plays an audio of the second channel according to the sound signal of the second channel. The sound signal adjustment method includes the following steps of receiving an audio and generating an input signal according to the audio; receiving the input signal; comparing the input signal with a predetermined signal; and controlling the first sound device to receive the sound signal of the second channel, and controlling the second sound device to receive the sound signal of the first channel when the input signal less than the predetermined signal.

As mentioned above, the electronic apparatus and sound signal adjustment method of the electronic apparatus can play the correct audio through the suitable sound device by calculating the receiving time span or the strength of the audio. Therefore the first sound device and the second sound device may not to reinstall if they are located at wrong position.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

The parts in the drawings are not necessarily drawn to scale, the emphasis instead being placed upon clearly illustrating the principles of at least one embodiment. In the drawings, like reference numerals designate corresponding parts throughout the various diagrams, and all the diagrams are schematic.

FIG. 1 to FIG. 4 are schematic diagrams showing an electronic apparatus according to the first embodiment.

FIG. 5 to FIG. 8 are schematic diagrams showing an electronic apparatus according to the second embodiment.

FIG. 9 to FIG. 14 are schematic diagrams showing an electronic apparatus according to the third embodiment.

FIG. 15 is a flow chart showing a sound signal adjustment method according to the fourth embodiment.

FIG. 16 to FIG. 17 are flow charts showing a sound signal adjustment method according to the fifth embodiment.

FIG. 18 is a flow chart showing a sound signal adjustment method according to the sixth embodiment.

### DETAILED DESCRIPTION

The parts in the drawings are not necessarily drawn to scale, the emphasis instead being placed upon clearly illustrating the principles of at least one embodiment. In the drawings, like reference numerals designate corresponding parts throughout the various diagrams, and all the diagrams are schematic.

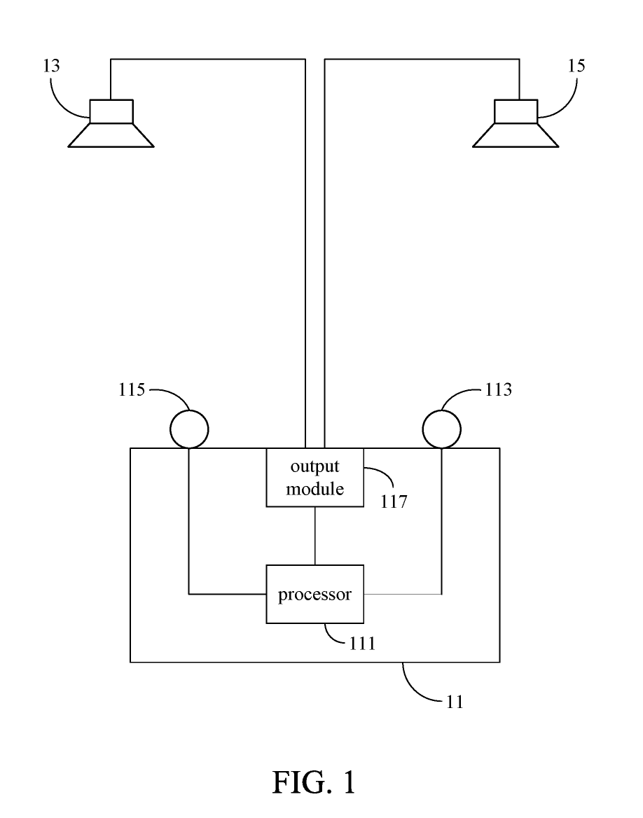

FIG. 1 is a schematic diagram showing an electronic apparatus 11 electrically connected to a first sound device 13 and a second sound device 15 according to a first embodiment of the invention. The electronic apparatus 11 includes a processor 111, a first sound-receiving module 113, a second sound-receiving module 115 and an output module 117. The processor 111 is electrically connected to the first sound-receiving module 113, the second sound-receiving module 115 and the output module 117. The output module 117 is electrically connected to the first sound device 13 and the second sound device 15. The first sound-receiving module 113 and the second sound-receiving module 115 are located at two sides of the electronic apparatus, respectively.

The electronic apparatus 11 may be a desktop, a laptop or a television. The first sound device 13 is a right-channel speaker of a speaker system and the second sound device 15 is a left-channel speaker of the speaker system.

The first sound-receiving module 113 and the second sound-receiving module 115 may be a microphones or other element having the function of sound capturing. The output module 117 may be a universal serial bus (USB) terminal, a high definition multimedia interface (HDMI) terminal, a Thunderbolt terminal, an IEEE 1394 terminal, an external PCI Express terminal, a banana plug, a banana jack, a 2.5 mm TRS connector or a RCA connector.

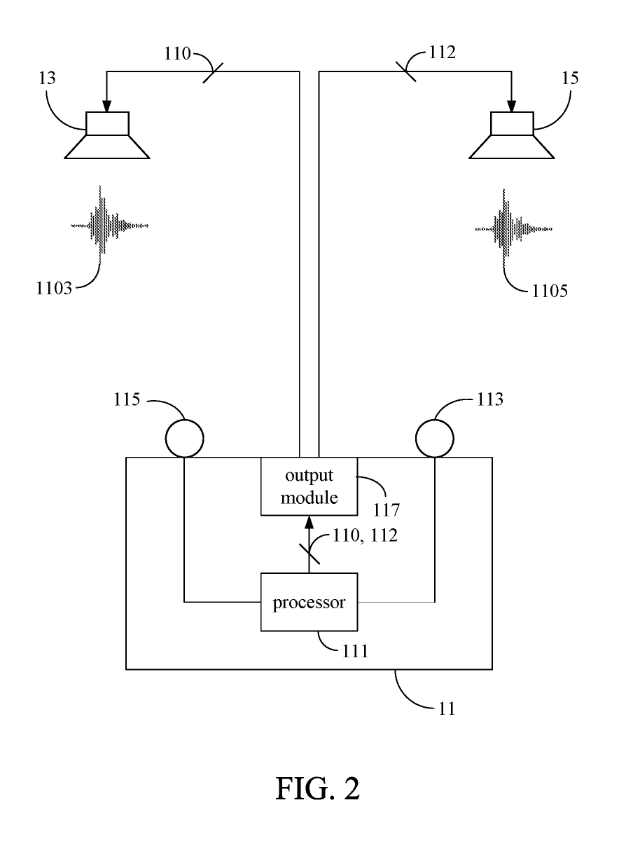

The operation procedure of the sound signal adjustment of the electronic apparatus 11 is described as following. Referring to FIG. 2, a sound signal of a first channel 110 and a sound signal of a second channel 112 is transmitted to the output module 117 from the processor 111. The first sound device 13 receives the sound signal of the first channel 110 through the output module 117 and plays an audio of the first channel 1103 according to the sound signal of a first channel 110. The second sound device 15 receives the sound signal of the second channel 112 through the output module 117 and plays an audio of the second channel 1105 according to the sound signal of a second channel 112. In the embodiment, the first channel is a right channel and the second channel is a left channel. In addition, it is to be noted that the first sound device 13 and the second sound device is located at the wrong position to play the audio of the right channel 1103 and the audio of the left channel 1105.

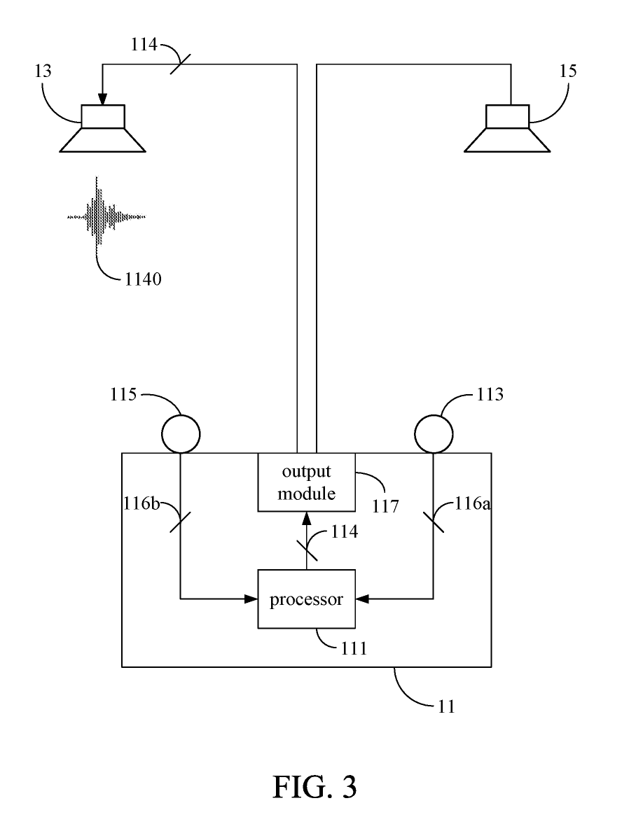

Referring to FIG. 3, a reference signal of the right channel 114 is transmitted to the output module 117 from the processor 111. The first sound device 13 receives the reference signal of the right channel 114 through the output module 117 and plays a reference audio of the right channel 1140 according to the reference signal of the right channel 114. The first sound-receiving module 113 receives the reference audio of the right channel 1140 and generates a first input signal 116a when the reference audio of the right channel 1140 is played by the first sound device 13. The second sound-receiving module 115 also receives the reference audio of the right channel 1140 and generates a second input signal 116b when the reference audio of the right channel 1140 is played by the first sound device 13. Then, the first input signal 116a is transmitted to the processor 111 by the first sound-receiving module 113 and the second input signal 116b is transmitted to the processor 111 by the second sound-receiving module 115.

A receiving time span of the first input signal 116a and the second input signal 116b is calculating by the processor 111 when the two signals are received. Referring to FIG. 3, the receiving time of the first input signal 116a is late than the receiving time of the second input signal 116b due to the first sound-receiving module 113 is located adjacent to the second sound device 15 and the second sound-receiving module 115 is located adjacent to the first sound device 13. Therefore, the processor 111 determines that the first sound device 13 and the second sound device 15 are located at the wrong position to play the audio of the right channel and the left channel.

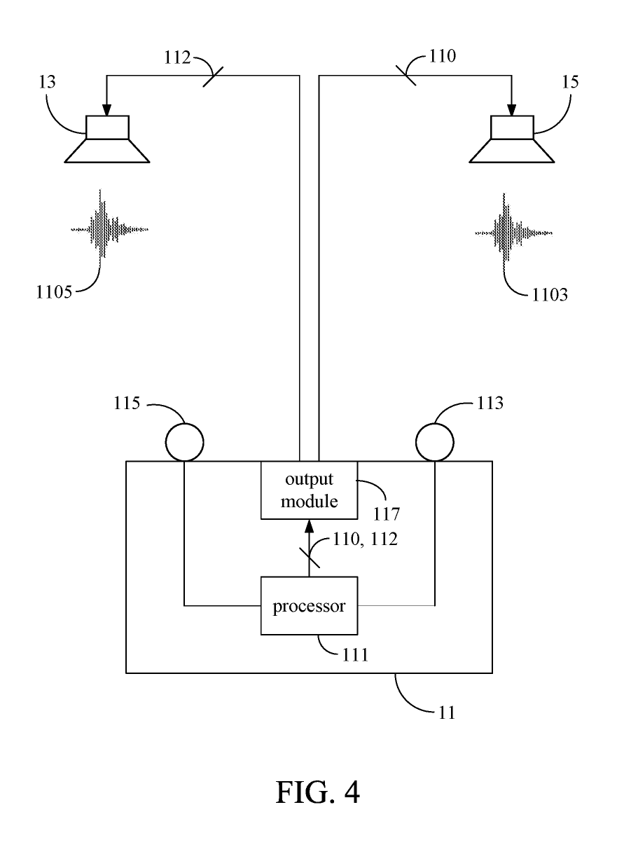

Referring to FIG. 4. the sound signal of the right channel 110 and the sound signal of the left channel 112 are adjusted by the processor 111 so that the first sound device 13 receives the sound signal of the second channel 112 and plays the audio of the left channel 1105 and the second sound device 15 receives the sound signal of the first channel 110 and plays the audio of the right channel 1103. Therefore, the audio of the right channel 1103 is played by the second sound device 15 and the audio of the left channel 1105 is played by the first sound device at the correct position.

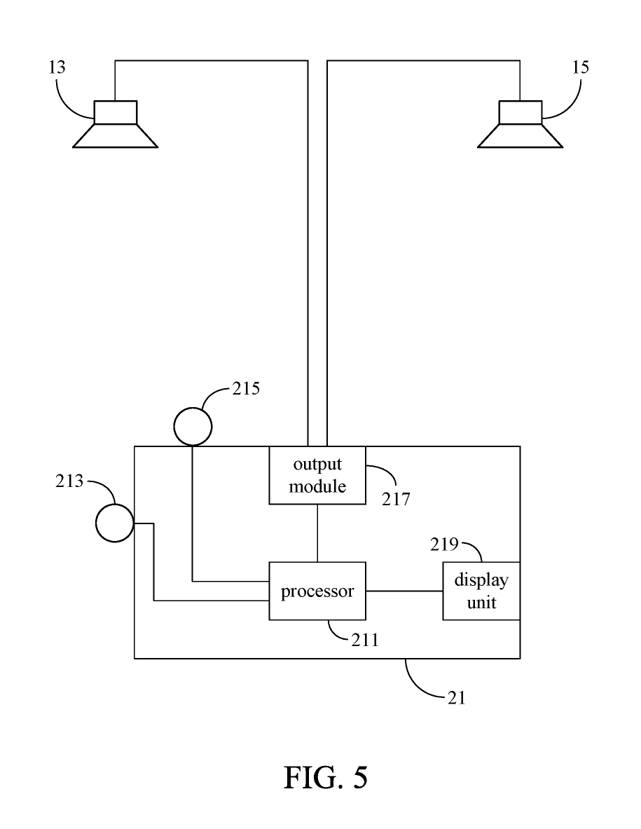

FIG. 5 is a schematic diagram showing the electronic apparatus 21 electrically connected to the first sound device 13 and the second sound device 15 according to a second embodiment of the invention. Referring to FIG. 5, the first sound device 13 is located at one side of the electronic apparatus 21 and the second sound device 15 is located at another side of the electronic apparatus 21. The electronic apparatus 21 includes a processor 211, a first sound-receiving module 213, a second sound-receiving module 215, an output module 217 and a display unit 219. The processor 211 is electrically connected to the first sound-receiving module 213, the second sound-receiving module 215, the output module 217 and the display unit 219. The output module 217 is electrically connected to the first sound device 13 and the second sound device 15.

It is similar to the first embodiment, the first sound-receiving nodule 213 and the second sound-receiving module 215 may be a microphones or other element having the function of sound capturing. The output module 217 may be a universal serial bus (USB) terminal, a high definition multimedia interface (HDMI) terminal, a Thunderbolt terminal, an IEEE 1394 terminal, an external PCI Express terminal, a banana plug, a banana jack, a 2.5 mm TRS connector or a RCA connector.

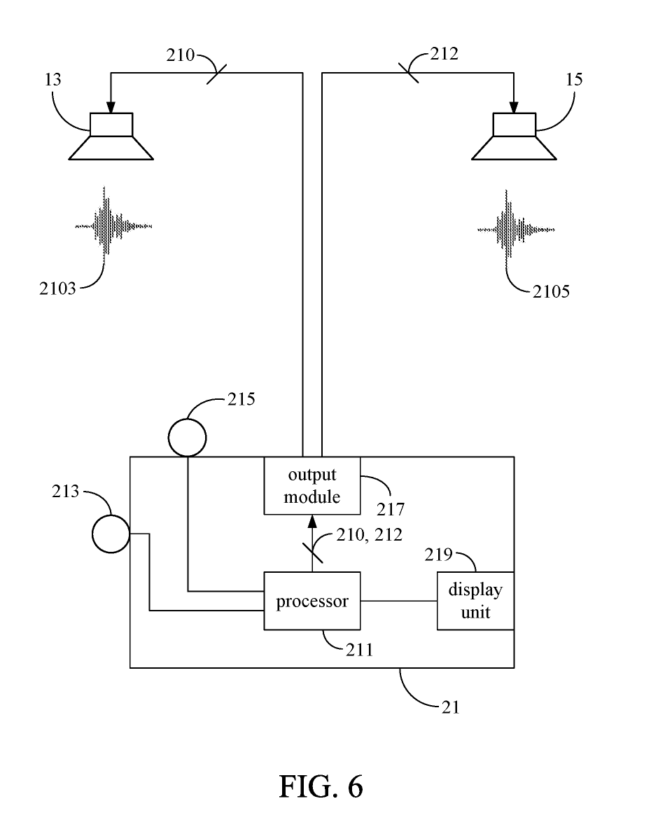

The operation procedure of the sound signal adjustment of the electronic apparatus 21 is described as following. Referring to FIG. 6, a sound signal of a first channel 210 and a sound signal of a second channel 212 is transmitted to the output module 217 from the processor 211. The first sound device 13 receives the sound signal of the first channel 210 through the output module 217 and plays an audio of the first channel 2103 according to the sound signal of a first channel 210. The second sound device 15 receives the sound signal of the second channel 212 through the output module 217 and plays an audio of the second channel 2105 according to the sound signal of a second channel 212. In the embodiment, the first channel is a right channel and the second channel is a left channel. In addition, it is to be noted that the first sound device 13 and the second sound device is located at the wrong position to play the audio of the right channel 2103 and the audio of the left channel 2105.

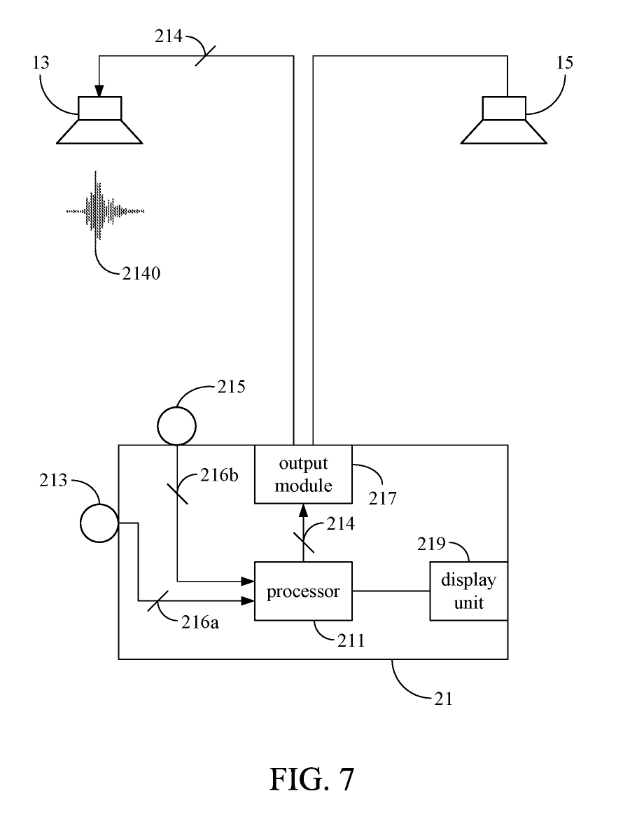

Referring to FIG. 7, a first reference signal of the right channel 214 is transmitted to the output module 217 from the processor 211. The first sound device 13 receives the first reference signal of the right channel 214 through the output module 217 and plays a first reference audio of the right channel 2140 according to the first reference signal of the right channel 214. The first sound-receiving module 213 receives the first reference audio of the right channel 2140 and generates a first input signal 216a when the first reference audio of the right channel 1140 is played by the first sound device 13. The second sound-receiving module 215 also receives the first reference audio of the right channel 2140 and generates a second input signal 216b when the first reference audio of the right channel 2140 is played by the first sound device 13. Then, the first input signal 216a is transmitted to the processor 211 by the first sound-receiving module 213 and the second input signal 216b is transmitted to the processor 211 by the second sound-receiving module 215.

A receiving time span of the first input signal 216a and the second input signal 216b is calculating by the processor 211 when the two signals are received. Referring to FIG. 7, the receiving time of the first input signal 216a is late than the receiving time of the second input signal 216b due to the second sound-receiving module 215 is located adjacent to the first sound device 13. Therefore, the processor 211 determines that the first sound device 13 and the second sound device 15 are located at the wrong position to play the audio of the right channel and the left channel.

It is similar to the first embodiment that the sound signal of the first channel 210 and the sound signal of the second channel 212 are adjusted by the processor 211 of the electronic apparatus 21. Those of ordinary skill in the art may readily appreciate how the processor 211 of the invention adjusts the sound signal of the first channel 210 and the sound signal of the second channel 212 according to other manners, so this will not be further described herein.

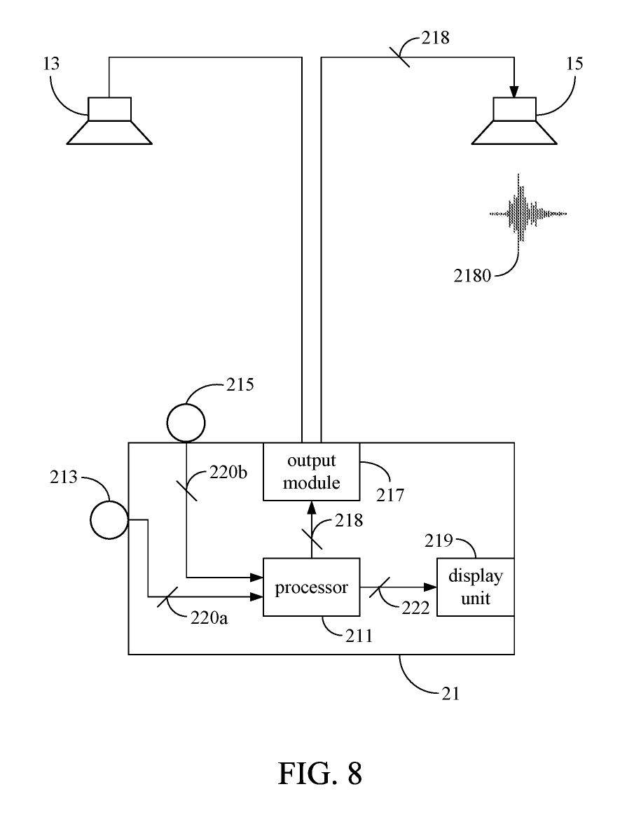

Referring to FIG. 8, a second reference signal of the left channel 218 is transmitted to the output module 217 from the processor 211. The second sound device 15 receives the second reference signal of the left channel 218 through the output module 217 and plays a second reference audio of the left channel 2180 according to the second reference signal of the left channel 218. The first sound-receiving module 213 receives the second reference audio of the left channel 2180 and generates a third input signal 220a when the second reference audio of the left channel 2180 is played by the second sound device 15. The second sound-receiving module 215 also receives the second reference audio of the left channel 2180 and generates a fourth input signal 220b when the second reference audio of the left channel 2180 is played by the second sound device 15. Then, the third input signal 220a is transmitted to the processor 211 by the first sound-receiving module 213 and the fourth input signal 220b is transmitted to the processor 211 by the second sound-receiving module 215.

A receiving time span of the third input signal 220a and the fourth input signal 220b is calculating by the processor 211 when the two signals are received. Referring to FIG. 8, the receiving time of the third input signal 220a is late than the receiving time of the fourth input signal 220b due to the second sound-receiving module 215 is located adjacent to the second sound device 15. Therefore, the processor 211 determines that the first sound device 13 and the second sound device 15 are located at the correct position to play the audio of the right channel and the left channel.

Then, an alert signal 222 is generated by the processor 211 due to the result of the receiving time span between first input signal 216a and the second input signal 216b and the receiving time span between third input signal 220a and the fourth input signal 220b is contradiction.

Finally, the display unit 219 receives the alert signal 222 from the processor 211. Alert information is displayed on the display unit 219 to notice the user that the first sound-receiving module 213 and the second sound-receiving module are located at the wrong position.

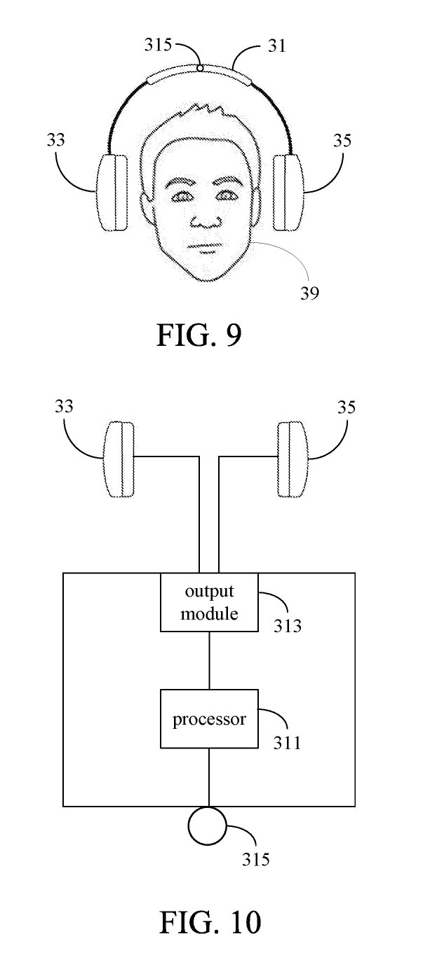

FIG. 9 is a schematic diagram showing a user wearing correctly a headset. The headset includes an electronic apparatus 31 electrically connected to a first sound device 33 and a second sound device 35. The first sound device 33 is a right channel speaker and the second sound device 35 is a left channel speaker. FIG. 10 is a schematic diagram showing the electronic apparatus 31 according to the third embodiment. The electronic apparatus 31 includes a processor 311, a sound receiving module 315 and a output module 313. The processor 311 is electrically connected to the sound receiving module 315 and the output module 313. The output module 313 is electrically connected to the first sound device 33 and the second sound device 35. The sound receiving module 315 is located between the first sound device 33 and the second sound device 35 and toward the front of the user 39.

The sound-receiving module 315 may be a directionality microphone or other element having the function of sound capturing. The output module 313 may be a universal serial bus (USB) terminal, a high definition multimedia interface (HDMI) terminal, a Thunderbolt terminal, an IEEE 1394 terminal, an external PCI Express terminal, a banana plug, a banana jack, a 2.5 mm TRS connector or a RCA connector.

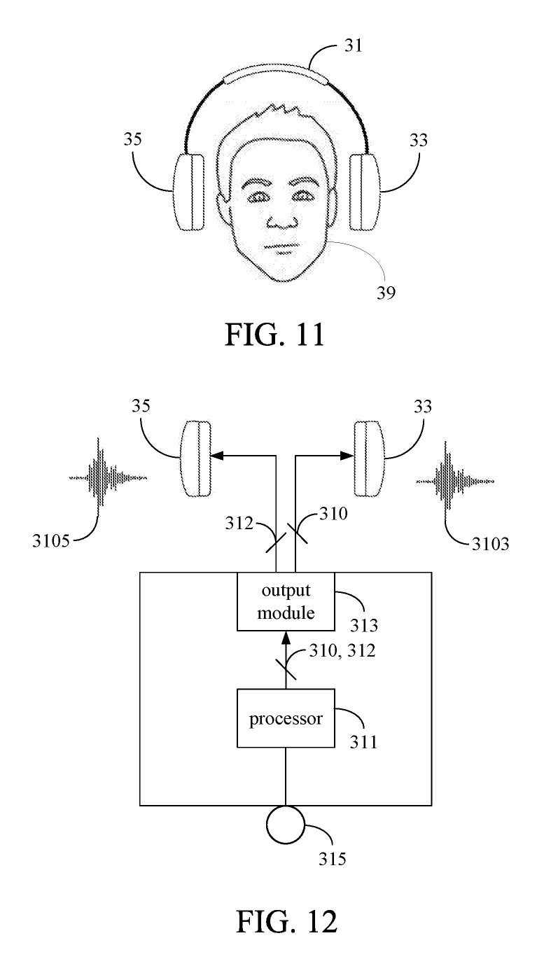

FIG. 11 to FIG. 14 are showing the operating procedure of the electronic apparatus 31 that a user 39 is wearing incorrectly a headset. FIG. 11 is a schematic diagram showing a user is wearing incorrectly a headset that the sound-receiving module 315 is toward behind the user 39. Referring to FIG. 12, a sound signal of a first channel 310 and a sound signal of a second channel 312 is transmitted to the output module 313 from the processor 311. The first sound device 33 receives the sound signal of the first channel 310 through the output module 313 and plays an audio of the first channel 3103 according to the sound signal of the first channel 310. The second sound device 35 receives the sound signal of the second channel 312 through the output module 313 and plays an audio of the second channel 3105 according to the sound signal of a second channel 312. In the embodiment, the first channel is a right channel and the second channel is a left channel. As mentioned above, the first sound device 33 and the second sound device 35 are located at the wrong position to play the audio of the right channel and the left channel due to the first sound device is closed to the left ear of the user 39 and the second sound device is closed to the right ear of the user 39.

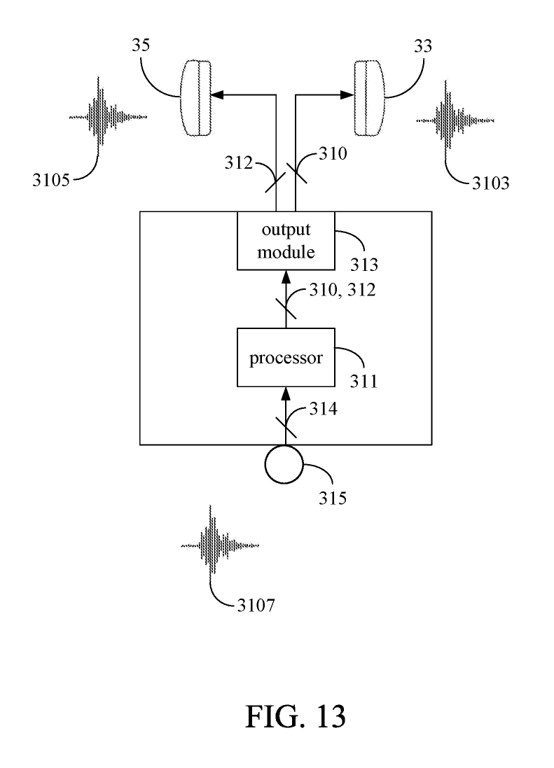

Referring to FIG. 13, when the sound adjustment procedure is operated by the electronic apparatus 31, the sound receiving module 315 receives an audio 3107 to generate an input signal 314. In the embodiment, the audio 3107 is a voice audio or a breathy audio. Then, the input signal 314 is transmitted to the processor 311 from the sound receiving module 315. The processor 311 compares the input signal 314 with a predetermined signal after the input signal 314 is received. In the embodiment, the basis for comparison is the decibel (dB) of the sound (corresponding to the input signal 314 and the predetermined signal). The processor 311 determines that the headset is worn incorrectly when the input signal 314 is less than the predetermined signal.

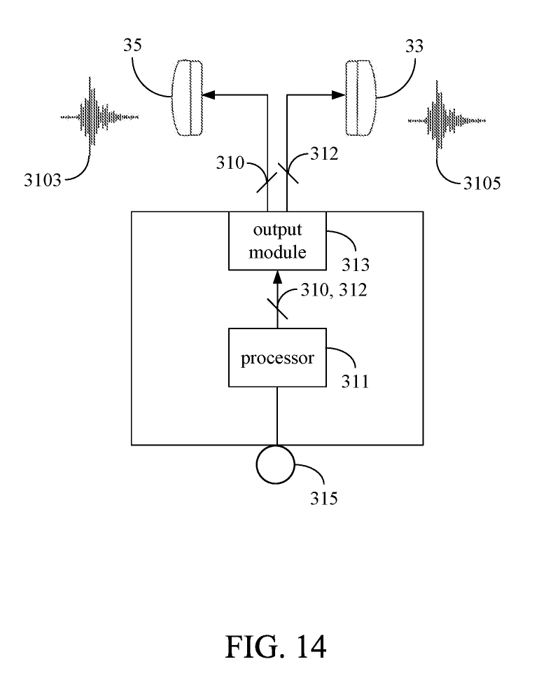

Referring to FIG. 14, after the judgment of the processor 311, the sound signal of the right channel 310 and the sound signal of the left channel 312 are adjusted by the processor 311 so that the first sound device 33 receives the sound signal of the left channel 312 and plays the audio of the left channel 3105 and the second sound device 35 receives the sound signal of the right channel 310 and plays the audio of the right channel 3103. Therefore, the audio of the right channel 3103 is played by the second sound device 35 and the audio of the left channel 3105 is played by the first sound device 33 at the correct position.

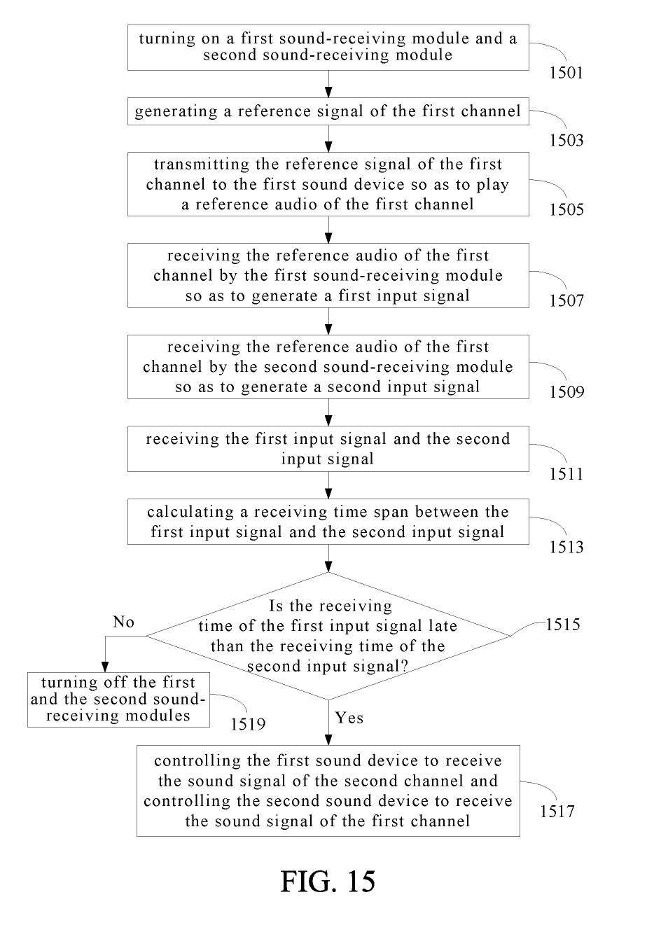

FIG. 15 is a flow chart showing a sound signal adjustment method of an electronic apparatus, for example the electronic apparatus 11 described in the first embodiment according to the fourth embodiment of the present invention. The electronic apparatus is electrically connected to the first sound device and the second sound device. The first sound device receives a sound signal of a first channel and plays an audio of the first channel according to the sound signal of the first channel. The second sound device receives a sound signal of a second channel and plays an audio of the second channel according to the sound signal of the second channel.

The sound signal adjustment method of the fourth embodiment includes step 1501 to step 1519. In step 1501, the first sound receiving module and the second sound receiving module are turned on. In step 1503, a reference signal of a first channel is generated. In step 1505, the reference signal of the first channel is transmitted to the first sound device so as to play a reference audio of the first channel according to the reference signal of the first channel. In step 1507, the reference audio of the first channel is received by the first sound receiving module so as to generate a first input signal. In step 1509, the reference audio of the first channel is received by the second sound receiving module so as to generate a second input signal. In step 1511, the first input signal and the second input signal are transmitted to the processor. In step 1513, a receiving time span between the first input signal and the second input signal is calculating by the processor. In step 1515, the processor determines whether the receiving time of the first input signal is late than the receiving time of the second input signal.

The step 1517 is performed when the receiving time of the first input signal is late than the receiving time of the second input signal. In step 1517, the sound signal of the first channel and the sound signal of the second channel are adjusted so that the sound signal of the second channel is received by the first sound device and the sound signal of the first channel is received by the first sound device. In addition, the step 1519 is performed when the receiving time of the first input signal is earlier than the receiving time of the second input signal. In step 1519, the first sound receiving module and the second sound receiving module are turned off.

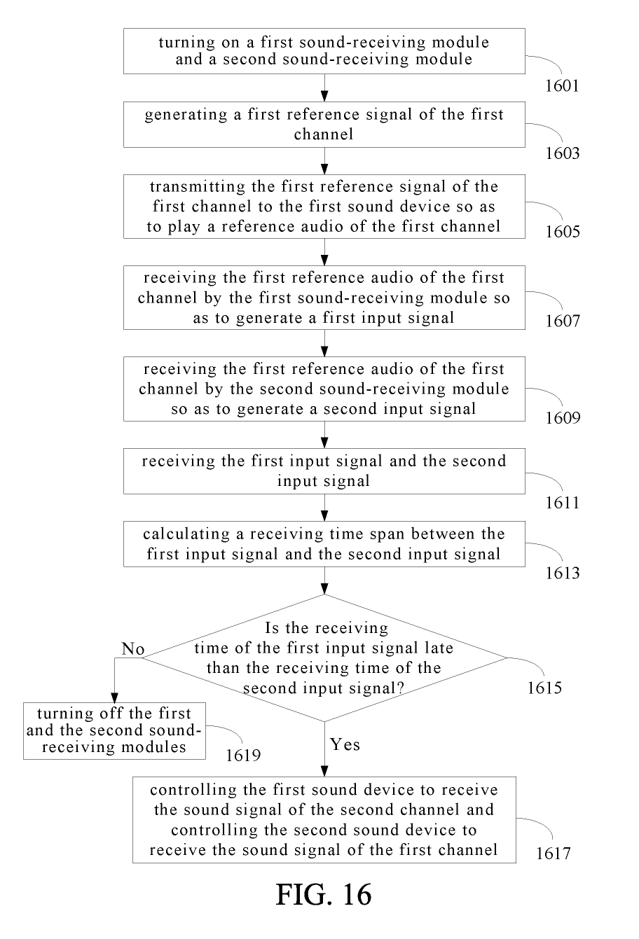

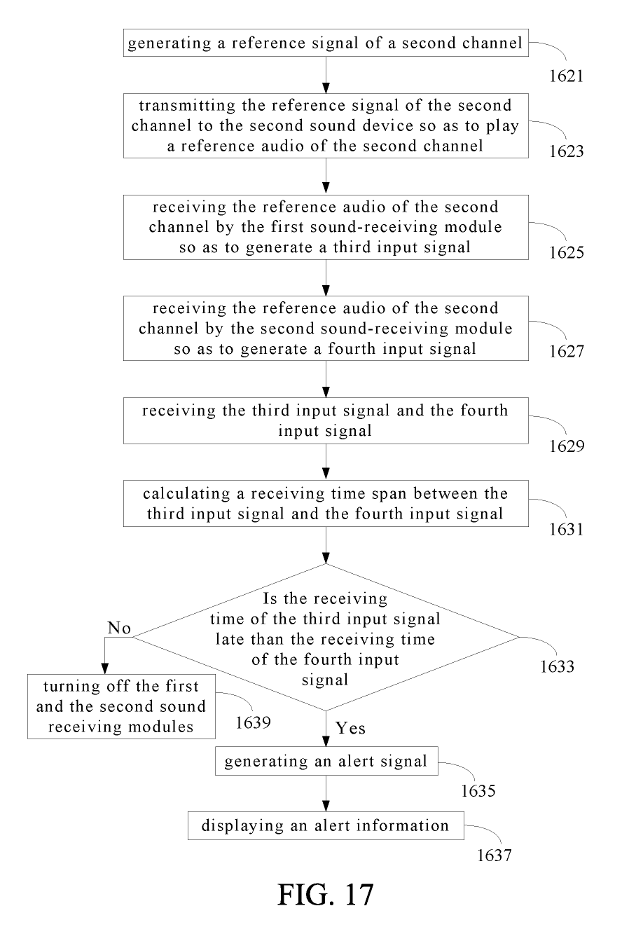

FIG. 16 and FIG. 17 are flow charts showing a sound signal adjustment method of an electronic apparatus, for example the electronic apparatus 21 described in the second embodiment according to the fifth embodiment of the present invention. The electronic apparatus is electrically connected to the first sound device and the second sound device. The first sound device receives a sound signal of a first channel and plays an audio of the first channel according to the sound signal of the first channel. The second sound device receives a sound signal of a second channel and plays an audio of the second channel according to the sound signal of the second channel.

The sound signal adjustment method of the fifth embodiment includes step 1601 to step 1639. In step 1601, the first sound receiving module and the second sound receiving module are turned on. In step 1603, a first reference signal of the first channel is generated. In step 1605, the first reference signal of the first channel is transmitted to the first sound device so as to play a first reference audio of the first channel according to the first reference signal of the first channel. In step 1607, the first reference audio of the first channel is received by the first sound receiving module so as to generate a first input signal. In step 1609, the first reference audio of the first channel is received by the second sound receiving module so as to generate a second input signal. In step 1611, the first input signal and the second input signal are transmitted to the processor. In step 1613, a receiving time span between the first input signal and the second input signal is calculating by the processor. In step 1615, the processor determines whether the receiving time of the first input signal is late than the receiving time of the second input signal.

The step 1617 is performed when the receiving time of the first input signal is late than the receiving time of the second input signal. In step 1617, the sound signal of the first channel and the sound signal of the second channel are adjusted so that the sound signal of the second channel is received by the first sound device and the sound signal of the first channel is received by the first sound device. In addition, the step 1619 is performed when the receiving time of the first input signal is earlier than the receiving time of the second input signal. In step 1619, the first sound receiving module and the second sound receiving module are turned off.

In step 1621, a second reference signal of the second channel is generated. In step 1623, the second reference signal of the second channel is transmitted to the second sound device so as to play a second reference audio of the second channel according to the second reference signal of the second channel. In step 1625, the second reference audio of the second channel is received by the first sound receiving module so as to generate a third input signal. In step 1627, the second reference audio of the second channel is received by the second sound receiving module so as to generate a fourth input signal. In step 1629, the third input signal and the fourth input signal are transmitted to the processor. In step 1631, a receiving time span between the third input signal and the fourth input signal is calculating by the processor. In step 1633, the processor determines whether the receiving time of the third input signal is late than the receiving time of the fourth input signal.

The step 1635 is performed when the receiving time of the third input signal is late than the receiving time of the fourth input signal. In step 1635, an alert signal is generated. In step 1637, the alert signal is transmitted to a display so as to display alert information according to the alert signal. In addition, the step 1639 is performed when the receiving time of the third input signal is earlier than the receiving time of the fourth input signal. In step 1639, the first sound receiving module and the second sound receiving module are turned off.

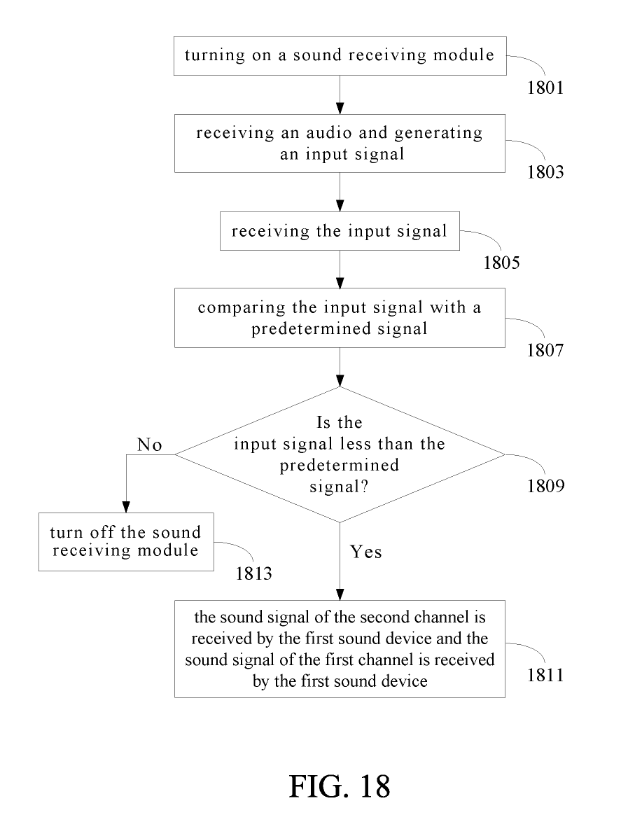

FIG. 18 is a flow chart showing a sound signal adjustment method of an electronic apparatus, for example the electronic apparatus 31 described in the first embodiment according to the sixth embodiment of the present invention. The electronic apparatus is electrically connected to the first sound device and the second sound device. The first sound device receives a sound signal of a first channel and plays an audio of the first channel according to the sound signal of the first channel. The second sound device receives a sound signal of a second channel and plays an audio of the second channel according to the sound signal of the second channel.

The sound signal adjustment method of the sixth embodiment includes step 1801 to step 1813. In step 1801, a sound receiving module is turned on. In step 1803, an audio is transmitted to the sound receiving module so as to generate an input signal. In step 1805, the input signal is transmitted to the processor. In step 1807, the strength of the input signal and the strength of the predetermined signal are compared by the processor. In step 1809, the processor determines whether the strength of the input signal is less than the strength of the predetermined signal.

The step 1811 is performed when the strength of the input signal is less than the strength of the predetermined signal. In step 1811, the sound signal of the first channel and the sound signal of the second channel are adjusted so that the sound signal of the second channel is received by the first sound device and the sound signal of the first channel is received by the first sound device. In addition, the step 1813 is performed when the strength of the input signal is greater than the strength of the predetermined signal. In step 1813, the sound receiving module is turned off.

In summary, the electronic apparatus and sound signal adjustment method of the electronic apparatus can play the correct audio through the suitable sound device by calculating the receiving time span or the strength of the audio. Therefore the first sound device and the second sound device may not to reinstall if they are located at wrong position.

Even though numerous characteristics and advantages of certain inventive embodiments have been set out in the foregoing description, together with details of the structures and functions of the embodiments, the disclosure is illustrative only. Changes may be made in detail, especially in matters of arrangement of parts, within the principles of the present disclosure to the full extent indicated by the broad general meaning of the terms in which the appended claims are expressed.

What is claimed is:

1. An electronic apparatus is electrically connected to a first sound device and a second sound device, wherein the first sound device receives a sound signal of a first channel and plays an audio of the first channel according to the sound signal of the first channel, and the second sound device receives a sound signal of a second channel and plays an audio of the second channel according to the sound signal of the second channel, comprising:
an output module that is electrically connected to the first sound device and the second sound device to transmit the sound signal of the first channel and the sound signal of the second channel;
a sound-receiving module that is located between the first sound device and the second sound device for receiving an audio so as to generate an input signal; and
a processor that is electrically connected to the output module and the sound-receiving module for receiving the input signal and comparing the input signal with a predetermined signal,
wherein the processor controls the first sound device to receive the sound signal of the second channel and the second sound device to receive the sound signal of the first channel when the input signal is less than the predetermined signal.

2. The electronic apparatus defined in claim 1, wherein the audio is a voice audio or a breathy audio.

3. A sound signal adjustment method cooperating with an electronic apparatus, which is electrically connected to a first sound device and a second sound device, wherein the first sound device receives a sound signal of a first channel and plays an audio of the first channel according to the sound signal of the first channel, and the second sound device receives a sound signal of a second channel and plays an audio of the second channel according to the sound signal of the second channel, comprising:
receiving an audio and generating an input signal according to the audio;
receiving the input signal;
comparing the input signal with a predetermined signal; and
controlling the first sound device to receive the sound signal of the second channel, and controlling the second sound device to receive the sound signal of the first channel when the input signal less than the predetermined signal.

4. The sound signal adjustment method defined in claim 3, wherein the audio is a voice audio or a breathy audio.

5. An electronic apparatus is electrically connected to a first sound device and a second sound device, wherein the first sound device receives a sound signal of a first channel and plays an audio of the first channel according to the sound signal of the first channel, and the second sound device receives a sound signal of a second channel and plays an audio of the second channel according to the sound signal of the second channel, comprising:
an output module that is electrically connected to the first sound device and the second sound device to transmit the sound signal of the first channel and the sound signal of the second channel;
a processor that is electrically connected to the output module and outputs a reference signal of the first channel to the first sound device through the output module to plays a reference audio of the first channel;
a first sound-receiving module that is electrically connected to the processor for receiving the reference audio of the first channel so as to generate a first input signal; and
a second sound-receiving module that is electrically connected to the processor for receiving the reference audio of the first channel so as to generate a second input signal,
wherein the processor receives the first input signal and the second input signal for calculating a receiving time span between the first input signal and the second input signal so as to control the first sound device to receive the sound signal of the second channel and control the second sound device to receive the sound signal of the first channel when the receiving time of the first input signal is late than the receiving time of the second input signal.

6. The electronic apparatus defined in claim 5, wherein the processor further generates a reference signal of the second channel for transmitting to the second sound device through the output module so that the second sound device plays a reference audio of the second channel according to the reference signal of the second channel, and the first sound-receiving module further receives the reference audio of the second channel to generate a third input signal, the second sound-receiving module further receives the reference audio of the second channel to generate a fourth input signal that the third input signal and the fourth input signal are transmitted to the processor for calculating a receiving time span between the third input signal and the fourth input signal so as to generate an alert signal when the receiving time of the third input signal is late than the receiving time of the fourth input signal.

7. The electronic apparatus defined in claim 6, further comprising a displaying unit that is electrically connected to the processor for receiving the alert signal so as to display alert information.

8. A sound signal adjustment method cooperating with an electronic apparatus, which is electrically connected to a first sound device and a second sound device, wherein the first sound device receives a sound signal of a first channel and plays an audio of the first channel according to the sound signal of the first channel, and the second sound device receives a sound signal of a second channel and plays an audio of the second channel according to the sound signal of the second channel, comprising the steps of:
generating a reference signal of the first channel;
transmitting the reference signal of the first channel to the first sound device so as to play a reference audio of the first channel according to the reference signal of the first channel;
receiving the reference audio of the first channel by the first sound-receiving module so as to generate a first input signal;
receiving the reference audio of the first channel by the second sound-receiving module so as to generate a second input signal;
receiving the first input signal and the second input signal;
calculating a receiving time span between the first input signal and the second input signal; and
controlling the first sound device to receive the sound signal of the second channel and controlling the second sound device to receive the sound signal of the first channel when the receiving time of the first input signal late than the receiving time of the second input signal.

9. The electronic apparatus defined in claim 8, further comprising the steps of:
generating a reference signal of a second channel;
transmitting the reference signal of the second channel to the second sound device so as to play a reference audio of the second channel according to the reference signal of the second channel;
receiving the reference audio of the second channel by the first sound-receiving module so as to generate a third input signal;
receiving the reference audio of the second channel by the second sound-receiving module so as to generate a fourth input signal;
receiving the third input signal and the fourth input signal;
calculating a receiving time span between the third input signal and the fourth input signal; and
generating an alert signal when the receiving time of the third input signal late than the receiving time of the fourth input signal.

10. The electronic apparatus defined in claim 9, further comprising the steps of:
receiving the alert signal; and
displaying an alert information according to the alert signal.
